(19) United States
(12) Patent Application Publication
(10) Pub. No.: US 2002/0135140 A1
(43) Pub. Date: Sep. 26, 2002

(54) Driver bit holder

(76) Inventors: David Mitchell, Carina (AU); Mark Wilson, Fig Tree Pocket (AU)

Correspondence Address: HOFFMAN WASSON & GITLER, 2361 JEFFERSON DAVIS HIGHWAY, SUITE 522, ARLINGTON, VA, 22202

(21) Appl. No.: 10/100,124

(22) Filed: Mar. 19, 2002

(30) Foreign Application Priority Data
Mar. 22, 2001 (AU) PR3896

(51) Int. Cl. B23B 31/117

(52) U.S. Cl. 279/79; 279/128; 279/145

(57) ABSTRACT

A driver bit holder (11) for releasably receiving a driver bit (10) and for minimising damage to the bit (10) and to a fastener that the bit (10) engages. The holder (11) has a main body (20) with a bore (21) at one end for releasably receiving the bit (10), a shank (30) extending from an opposite end of the body (20) and extending into a bore (34) at the opposite end of the body (20), wherein the shank (30) has an inner end (35) with a transverse cross sectional shape corresponding to the transverse cross sectional shape of the bore (34), and a rubber sleeve (37) extending about the inner end (35) and located between the inner end (35) and the bore (34).

This invention relates to a driver bit holder.

Driver bits for use with power tools such as electric drills are known. These driver bits have a shank and a head. The head is configured to be cooperative with fasteners having complementary head configurations. For example, where the fasteners have a PHILLIPS® head configuration then the head of the driver bit has a complementary head configuration.

Bit holders are employed for receiving the driver bit and the holder has a shank and a coupling. One end of the holder receives a shank which may be held within a chuck of the electric drill and the other end of the holder releasably receives the driver bit. The driver bit may readily be removed and replaced once it has worn without the need for removing the holder from the chuck of the electric drill.

With these known holders there is a tendency for premature wear of the head of the driver bit or damage of the head of the fastener to occur when the fastener is tightened or when the driver bit bites relative to the fastener head during use.

### SUMMARY OF THE INVENTION

It is an object of the invention to provide a driver bit holder which at least minimises the disadvantages mentioned above.

According to one aspect, the invention provides a driver bit holder for releasably receiving a driver bit, the holder having:

a body with a bore at one end for releasably receiving a driver bit;

a shank extending from an opposite end of the holder body and extending into a bore at the opposite end of the body, the shank having an inner end with a transverse cross sectional shape corresponding to the transverse cross sectional shape of the bore at the opposite end of the body; and

a sleeve of elastomeric material extending about the inner end of the shank and located between the inner end and the bore at the opposite end of the body.

It is preferred that the elastomeric material from which the sleeve is made be rubber. The sleeve takes up the space between the bore in the body of the holder and the inner end of the shank.

Whilst the bore and the inner end of the shank may be of any suitable complementary transverse cross sectional shape, it is preferred that they be of a triangular shape. An equilateral triangular shape is particularly preferred.

The sleeve is of a triangular shape when the bore and inner end are triangular and the corners of the sleeve are curved preferably at a radius of about 0.5 mm.

### BRIEF DESCRIPTION OF THE DRAWINGS

A particular preferred embodiment of the invention will now be described by way of example with reference to the drawings in which:

FIG. 1 is a part longitudinal sectional view of a driver bit holder of an embodiment of the invention; and

FIG. 2 is a transverse sectional view taken along line II-II of FIG. 1.

### DETAILED DESCRIPTION OF THE PREFERRED EMBODIMENT

In all of the drawings like reference numerals refer to like parts.

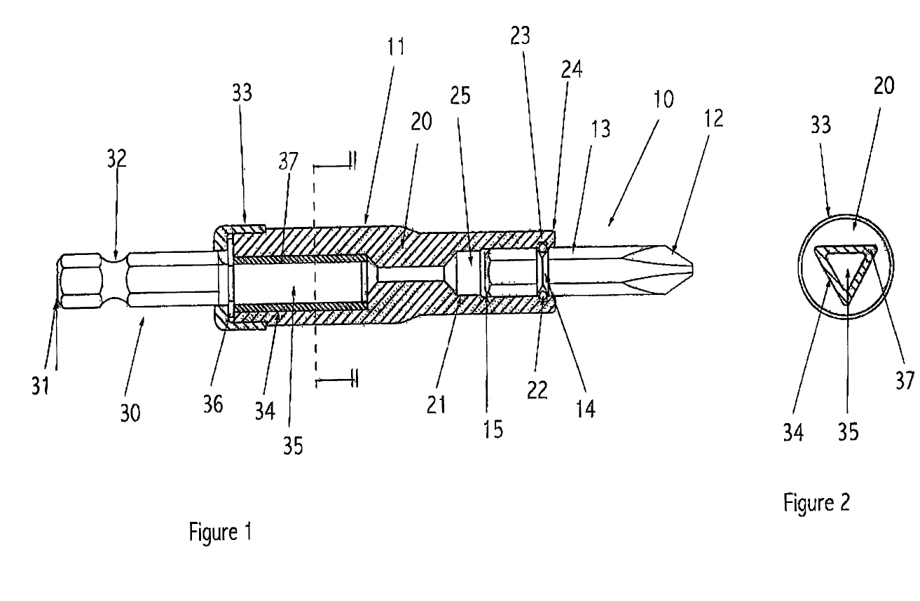

FIG. 1 shows a driver bit 10 releasably received by a driver bit holder 11. The bit 10 has a head 12 and a shank 13. The shank has a notch or reduced diameter portion 14 between the head 12 and a free end 15.

The holder 11 has a main body 20 with a bore 21 for receiving the bit 10, a circlip or retainer 22 is located in a groove 23 located near end 24 of the body 20. The retainer 22 locates relative to portion 14 of the bit 10 to releasably couple the bit 10 relative to the holder 11.

Bore 21 has a transverse cross sectional shape corresponding to the transverse cross sectional shape of the bit 10. In this embodiment the bit 10 has a hexagonal transverse cross sectional shape and the bore 21 is likewise hexagonal in transverse cross section. A magnet 25 may be positioned within the bore 21 to assist in releasably coupling the bit 10 relative to the holder 11.

The holder 11 has a shank 30 with a transverse hexagonal shape for reception by a chuck of an electric drill. The shank 30 has a free end 31 and a reduced diameter portion 32.

A cover 33 extends over an end of the body 20 and has an aperture through which the shank 30 extends. The shank 30 extends into the body 20 and is received within a bore 34 extending into the body 20. The transverse sectional shape of the bore 34 corresponds to the transverse sectional shape of an inner end 35 of the shank 30.

A friction washer 36 is located between the cover 33 and the body 20 and locates within a groove on the shank 30 and is press fitted onto the shank 30. This groove is present at a location where the inner end 35 meets the remainder of the shank 30. The washer 36 fixes the shank 30 relative to the body 20.

As shown in FIG. 2, in this embodiment both the bore 34 and the inner end 35 of the shank 30 have a triangular transverse cross sectional shape. Other shapes which allow the end 35 and the bore to be maintained in driving contact are not excluded: for example square, hexagonal or other shapes may also be employed.

A sleeve 37 of elastomeric extends over end 35 and is located between the bore 34 and end 35. The sleeve 37 is preferably made of rubber. The corners of the sleeve 37 have a 0.5 mm radius.

The presence of the sleeve 37 between the end 35 and bore 34 acts as a shock absorber when the bit 10 received by the holder II is used to drive a fastener and minimises damage to the bit 10 and to the fastener that it engages.

1. A driver bit holder for releasably receiving a driver bit, the holder having:
a body with a bore at one end for releasably receiving a driver bit;
a shank extending from an opposite end of the holder body and extending into a bore at the opposite end of the body, the shank having an inner end with a transverse cross sectional shape corresponding to the transverse cross sectional shape of the bore at the opposite end of the body; and
a sleeve of elastomeric material extending about the inner end of the shank and located between the inner end and the bore at the opposite end of the body.

2. The driver bit holder of claim 1, wherein the sleeve fills the space between the bore at the opposite end of the body and the inner end of the shank.

3. The driver bit holder of claim 1, wherein the bore at the opposite end of the body, the inner end of the shank and the sleeve are triangular in shape when viewed in transverse cross section.

4. The driver bit holder of claim 3, wherein corners of the sleeve are curved at a radius of about 0.5 mm.

5. The driver bit holder of claim 1, wherein the bore at the one end of the body has a retainer for releasably coupling the driver bit to the holder.

6. The driver bit holder of claim 5, wherein the retainer is located in a groove of the bore at the one end of the body and engages a reduced diameter portion of a neck of the drill bit.

7. The driver bit holder of claim 1, wherein the bore at the one end of the body has a transverse cross sectional shape corresponding to the transverse cross-sectional shape of the driver bit.

8. The driver bit holder of claim 1 further having a magnet positioned within the bore at the one end of the body.

9. The driver bit holder of claim 1, wherein the shank is shaped for reception by a chuck of a drill.

10. The driver bit holder of claim 1, wherein the shank has a free end having a reduced diameter portion.

11. The driver bit holder of claim 1, wherein the body has a cover extending over the opposite end of the body and has an aperture through which the shank extends.

12. The driver bit holder of claim 1, wherein a friction washer is located between the cover and the body and fixes the shank relative to the body, the washer locates within a groove on the shank and is press fifted onto the shank.
